(19) United States
(12) Patent Application Publication
(10) Pub. No.: US 2005/0246929 A1
(43) Pub. Date: Nov. 10, 2005

(54) First aid prompt tag

(75) Inventor: Chia-Li Chu, Jhonghe City (TW)

Correspondence Address: BRUCE H. TROXELL;SUITE 1404, 5205 LEESBURG PIKE, FALLS CHURCH, VA, 22041, US

(73) Assignee: Hsiung-Chun CHU

(21) Appl. No.: 10/838,185

(22) Filed: May 5, 2004

(51) Int. Cl. G09F 21/02

(52) U.S. Cl. 40/586

(57) ABSTRACT

A first aid prompt tag includes a main member, which has label sides, a compartment and a hanging bole. The label sides are marked with first aid notice for being attacked suddenly and personal information of the patient such as name, phone number, address, blood type and case history and name and phone number of the emergency contact person. The compartment contains first aid medicine and the hanging hole for being passed through with a hanging thread. The hanging thread can be hung on the neck or hand of the patient so that the first aid prompt tag can be carried to help the patient himself or others beside the patient performing necessary first aid best help to the patient.

### BACKGROUND OF THE INVENTION

1. Field of the Invention

The present invention is related to first aid accessory for a patient and particularly to a first aid prompt tag, which can be carried with the patient, to be marked with first aid method in case of the patient being attacked and to be marked with information concerning identification of the patient and the contact person with a compartment being provided for storing first aid medicine such that the medicine can be taken out by the patient or others beside the patient during performing the first aid.

2. Brief description of related art:

Patients having chronic diseases such as high blood pressure, heart disease, diabetes mellitus and epilepsy can be attacked suddenly at any time and any places including taking bath in the bath room. It is very easy to result in paralytic stroke if the patients of high blood pressure and heart disease are not treated with proper first aid within 3 to 5 minutes right after sudden attack. Even more seriously, the patients may be dead in case of not being rescued in time. As for the patient of diabetes mellitus, it may result in stupor due to too much low blood sugar without being helped in time. First aid done by others is extremely required while a patient is unable to help himself or loses consciousness during being attacked. A stranger beside the patient is incapable of performing effective first aid within key timing due to being unaware of the patient's condition.

Some patients of high blood pressure, heart disease and diabetes mellitus carry first aid medicine with them for being able to take the medicine themselves in case of being attacked suddenly so as to avoid the worsening of illness. However, when the patients are unable to help themselves during being attacked suddenly, the key timing of the first aid may be lost because others do not know the patents have carried the medicine with them and do not want and dare to use the medicine to perform the first aid even they know the medicine is carried about with the patients.

### SUMMARY OF THE INVENTION

The crux of the present invention resides in that a first aid tag is provided for being carried by patients of chronic diseases such as high blood pressure, heart disease, diabetes mellitus and epilepsy with case history and first aid method thereon such that others can promptly learn the patient's condition and use the medicine therein to perform the first aid so as to avoid that the state of illness is getting worse or even more seriously the patient becomes dead due to not performing the first aid in time.

An object of the present invention is to provide a first aid prompt tag, which can be carried with the patient, for others beside the patient can perform the first aid according to instructions on the tag in case of the patient being attacked suddenly.

Another object of the present invention is to provide a first aid prompt tag, which has a container for receiving first aid medicine needed by the patient, for others or the patient himself being able to take out the medicine during performing the first aid.

A further object of the present invention is to provide a first aid prompt tag with which the personal identification information of the patient and phone number of the emergency contact person can be marked so that it is possible for others to reach the patient's relative or friend for helping the patient seeing a doctor or going home.

### BRIEF DESCRIPTION OF THE DRAWINGS

The present invention can be more fully understood by reference to the following description and accompanying drawings, in which:

FIG. 1 is a perspective view of a first aid prompt tag according to the present invention in which a plug is detached from a main member;

FIG. 2 is a perspective view similar to FIG. 1 in which the plug has blocked the main member of the first aid prompt tag;

FIG. 3 is a plan view of the first label side of the first aid prompt tag according to the present invention; and

FIG. 4 is a plan view of the second label side of the first aid prompt tag according to the present invention;

### DETAILED DESCRIPTION OF THE PREFERRED EMBODIENT

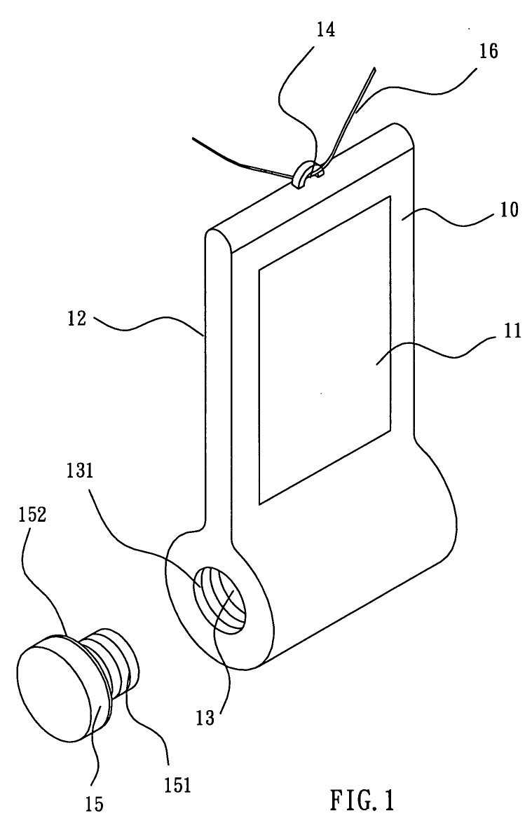

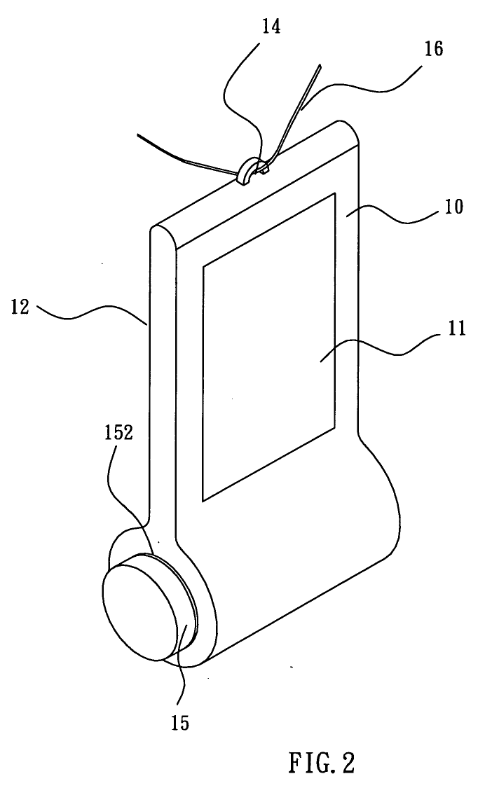

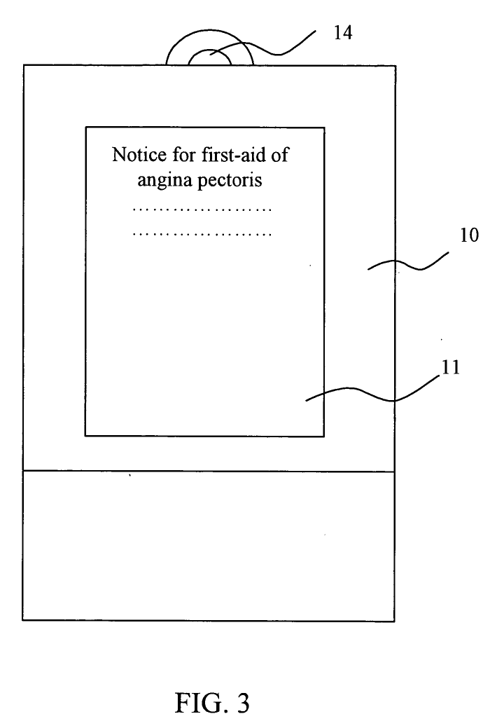

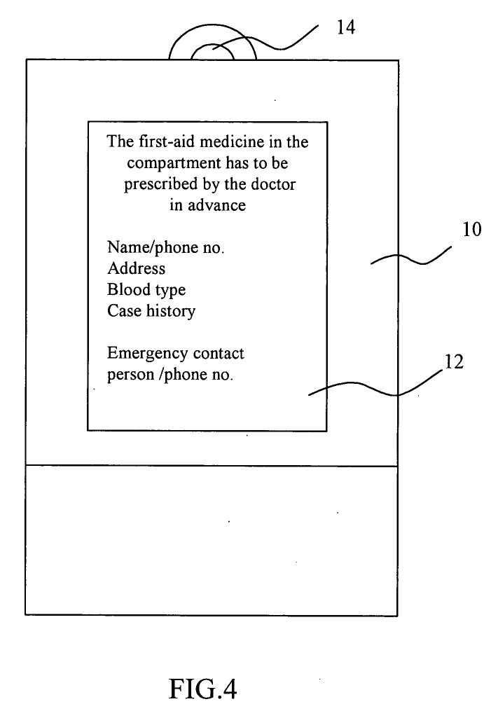

Referring to FIGS. 1 and 2, a first-aid prompt tag according to the present invention includes a main member 10, which has a first label side 11, a second label side 12, a compartment 13 and a hanging hole 14. The first label side 11 as shown in FIG. 3 indicates a first-aid notice for being used in case of the patient being attacked by chronic disease suddenly and the notice can be expressed such as “notice for first-aid of angina pectoris: put a tablet of medicine under tongue or at a lateral side of the mouth cavity for being melted and absorbed, another tablet of the medicine is taken after 5 minutes if the patient is not relieved and goes to see a doctor if it is ineffective after taking 3 tablets in 15 minutes; if there is no feeling of scorching hot under the tongue during taking the medicine, the medicine is expired and it is necessary to take a note of expiration date.” The second label side 12 is behind the first label side 11 as shown in FIG. 4 and it is recorded that “The first-aid medicine in the compartment has to be prescribed by the doctor in advance.” Information of patient's Name, phone number, address, blood type, case history and emergency contact person's name and phone number are also marked at the second label side 12. The compartment 13 is located under the first label sides 11 and the second label side 12 for storing first aid medicine with an opening provided with internal screw threads to engage with the screw rod 151 on a plug 15. The screw rod 151 is attached with an elastic washer 152 to allow the plug 15 closing the opening of the compartment 13 tightly. A hang hoe 14 is disposed at the top of the tag above the first and second label sides 11, 12 for an elongated soft object such as a hanging chain or a hanging thread 16 being able to pass through so that the first aid prompt tag of the present invention can be carried about with the patient by way of being hung on the neck or the hand of the patient with the hanging thread 16.

Both the main member 10 and the plug 15 used in the first aid prompt tag of the present invention can be made of acrylic material and the plug 15 also can be made of metallic material. The main member 10 can be integrally made with the compartment 13 or can be joined to a container with the compartment 13. Due to the washer 152 being placed between the plug 15 and the main member 10, the plug 15 can block the compartment 13 with air tightness, waterproof and dryness so as to prevent the medicine in the compartment 13 from going bad. The hanging chain or hang thread 16 is made of high temperature resistant and soft material for the patient feeling snug.

The first-aid notice, which is used in case of the patient being attacked by chronic disease suddenly and located on the first label side 11, can be printed directly to the first label side 11 or can be printed on a piece of water resistant stick paper before being stuck to the first label side 11. The personal information of the patient and the emergency contact person on the second label side 12 can be printed by the medical institute or pharmacy personnel or the patient himself or printed on a piece of stick paper before being stuck to the second label side 12. The personal information can be refrained from marking on the second label side 12 if privacy of the patient is needed to keep confidential.

It is appreciated that the first aid emergency tag of the present invention is possible to be carried with the patient at all times even during taking bath. The first aid medicine in the compartment can be taken out by the patient himself or others beside the patent at any time in case of the patient being attacked suddenly by the disease while the medicine is needed to take. The first aid notice on the first label side lets others know what the disease of the patient is and take effective action according to the first aid notice. The personal information of the patient and the emergency contact person is helpful for the helper to recognize who the patient is before guiding the patient back home or to notify the contact person before the subsequent treatment or to see a doctor immediately. Hence, it is very helpful for the patient himself or others beside the patient to perform necessary first aid and best help for the patient can be obtained promptly.

While the invention has been described with referencing to a preferred embodiment thereof, it is to be understood that modifications or variations may be easily made without departing from the spirit of this invention, which is defined by the appended claims.

1. A first aid prompt tag, comprising:
a main member, providing a label side and a compartment with a first aid notice for sudden attack on the label side and a space in the compartment for storing first aid medicine and the compartment having an opening; and
a plug, being engaged to the opening;
whereby, the first aid prompt tag can be carried with the patient to help the patient himself and others beside the patient performing necessary first aid in case of the patient being attacked suddenly.

2. The first aid prompt tag as defined in claim 1, wherein the label side is marked with information of names and phone numbers of the patient and emergency contact person.

3. The first aid prompt tag as defined in claim 1, wherein the label side is marked with personal information of the patient.

4. The first aid prompt tag as defined in claim 1, wherein the main member has a hang hole.

5. The first aid prompt tag as defined in claim 1, wherein the first aid notice is printed on the main member directly.

6. The first aid prompt tag as defined in claim 1, wherein the first aid notice is printed on a piece of stick paper before being stuck to the main member.

7. The first aid prompt tag as defined in claim 1, wherein the opening of the compartment is provided with internal screw threads and the internal screw threads engages with a screw rod of the plug.

8. The first aid prompt tag as defined in claim 1, wherein the main member is provided with a first label side and a second label side, which is at the back of the first label side, and the first aid notice for being suddenly attacked is marked on the first label side and the second label side is marked with “the first aid medicine has to be prescribed by the doctor in advance”.

9. The first aid prompt tag as defined in claim 3, wherein the personal information includes name, phone number, address, blood type and case history.

10. The first aid prompt tag as defined in claim 1, wherein the hanging hole is pierced with an elongated object for being worn by the patient.

11. The first aid prompt tag as defined in claim 7, wherein an elastic washer is attached to the screw rod to allow the plug blocking the opening in air tightness.

12. The first aid prompt tag as defined in claim 8, wherein the second label side is marked with name, phone number of the emergency contact person and personal information of the patient.
